(19) United States
(12) Patent Application Publication
(10) Pub. No.: US 2021/0010726 A1
(43) Pub. Date: Jan. 14, 2021

(54) Compressor Cooling Aggregate for a Refrigerator or a Cooler

(71) Applicant: Dometic Sweden AB, Solna (SE)

(72) Inventors: Peng Wang, JinWan (CN); Weixian Guan, JinWan (CN); Wenmin Tan, JinWan (CN); Feng Wang, JinWan (CN)

(21) Appl. No.: 16/924,888

(22) Filed: Jul. 9, 2020

(30) Foreign Application Priority Data
Jul. 10, 2019 (DE) 102019210222.0

(51) Int. Cl. F25B 31/00; F25B 13/00

(52) U.S. Cl. CPC F25B 31/006; F25B 13/00

(57) ABSTRACT

The present invention relates to a compressor cooling aggregate for a refrigerator or a cooler comprising a compressor base plate, a compressor, a condenser, a fan and a fan adapter, the fan adapter is configured to provide for an air flow path inside the fan adapter between the fan and the outside of the refrigerator or the cooler, wherein the fan is fixed to the fan adapter by means of at least one first snap structure. The present invention further relates to a cooler or refrigerator equipped with the compressor cooling aggregate.

### CLAIM TO PRIORITY

This non-provisional patent application claims priority to and benefit of, under 35 U.S.C. § 119(a), German Patent Application Serial Number DE 102019210222.0, filed Jul. 10, 2019, all of which is incorporated by reference herein.

### BACKGROUND

The present embodiments relate to a compressor cooling aggregate for a refrigerator or a cooler, and to a refrigerator or cooler equipped with the compressor cooling aggregate.

Compressor cooling aggregates typically include a compressor, a condenser and a fan, all of which are mounted onto a plate, commonly referred to as a compressor base plate. In particular in the field of coolers, i.e. mobile cooling boxes with active cooling, the cooling aggregates must have a compact design, because of the limited space. A further problem is the discharge of warmed-up air that is supposed to take away the heat energy from the condenser. Mostly, there is too much mixing of fresh cold air with the warmed-up air, thereby reducing the cooling capacity.

A further problem especially with coolers is the rather complicated mounting of the components on the compressor base plate, which is also due to the limited space. Typically, the components are mounted with separated fixing means like screws or bolts or the like. This renders the mounting procedure complicated and results in high costs.

It would be desirable, therefore, to eliminate the above-mentioned drawbacks.

### SUMMARY

In order to solve the above problem, the present embodiments provide a compressor cooling aggregate for a refrigerator or a cooler comprising a compressor base plate, a compressor, a condenser, a fan and a fan adapter. The fan adapter is configured to provide for an air flow path inside the fan adapter between the fan and the outside of the refrigerator or the cooler.

According to the embodiments, the fan is fixed to the fan adapter by at least one first snap structure. This reduces leakage of air flow pressure within the air flow path and insulates the cold and warm air from each other. Furthermore, complexity and costs are reduced.

In some embodiments, no screws are present to fix the fan to the fan adapter. This further reduces complexity and costs.

The condenser is arranged close to the fan and the fan is arranged close to the fan adapter, thereby defining an air flow path between the condenser and the outside of the refrigerator or the cooler. This reduces turbulences and air flow resistance, thereby improving the heat exchange efficiency.

The first snap structure may comprise a first snap-in nose being part of the fan adapter, which first snap-in nose engages with an edge of the fan. This provides for a save and efficient coupling without the need of separate fixing means.

The fan adapter may further comprise abutment portions extending away from the fan adapter in the vicinity of an area where the fan is fixed and the abutment portions are configured to laterally abut against the fan, thereby preventing the fan from moving with respect to the fan adapter and in a direction within the area where the fan is fixed. This increases the stability of the assembly.

The fan adapter may be fixed to the compressor base plate by at least one second snap structure. This further reduces the cost and the complexity of the mounting procedure.

In some embodiments, no screws are present to fix the fan adapter to the compressor base plate. This further reduces complexity and costs.

The second snap structure comprises a second snap-in nose being part of the fan adapter, which second snap-in nose engages with a snap-in cavity provided at the compressor base plate. This provides for a quick and easy mounting procedure.

The fan adapter may further be fixed to the compressor base plate by an hook-in structure comprising a tongue and an undercut portion. This provides for an increased stability of the respective connection.

The tongue may be present at one side of the fan adapter and at the bottom of the fan adapter, and the tongue protrudes horizontally away from the fan adapter. This represents a robust design which is easy to manufacture as a one-piece component.

The undercut portion may be present at the compressor base plate and is configured to cover a portion of the tongue in order to prevent the tongue from being lifted to the above. Thereby, the fan adapter is stably secured.

The undercut portion may comprise sidewalls configured to abut against lateral end portions of the tongue in order to prevent the tongue from laterally moving within the undercut portion. This further increases the stability of the connection.

The fan adapter may be fixed to the compressor base plate by at least two second snap structures and one hook-in structure. This provides for an efficient and effective coupling between the fan adapter and the compressor base plate.

The present embodiments further provide a cooler or refrigerator that is equipped with the compressor cooling aggregate according to the invention.

The cooler or refrigerator comprises a ventilation grill formed in an area of an outer cover of the cooler or refrigerator. The ventilation grill covers at least a portion of a cross-sectional area of the air flow path provided by the fan adapter, so that air flowing along the air flow path can pass the outer cover of the cooler or refrigerator through the ventilation grill. This provides for an efficient heat exchange.

### BRIEF DESCRIPTION OF THE DRAWINGS

In the following, an embodiment of the compressor refrigerator aggregate of the present invention are described in more detail with reference to the accompanying drawings, wherein

FIG. 1 shows a perspective view on the compressor cooling aggregate,

FIG. 2 shows a top view on a horizontal cross section of the compressor cooling aggregate of FIG. 1,

FIG. 3 shows a perspective view of the fan connected to the fan adapter,

FIG. 4 shows a perspective view of the fan adapter,

FIG. 5 shows a cross sectional view of the compressor cooling aggregate mounted to cooler,

FIG. 6 shows another cross-sectional view of the arrangement of FIG. 5,

FIG. 7 shows the second snap structure of the coupling between the fan adapter and the compressor base plate; and,

FIG. 8 illustrates the working principle of the hook-in structure of the coupling between the fan adapter and the compressor base plate.

### DETAILED DESCRIPTION

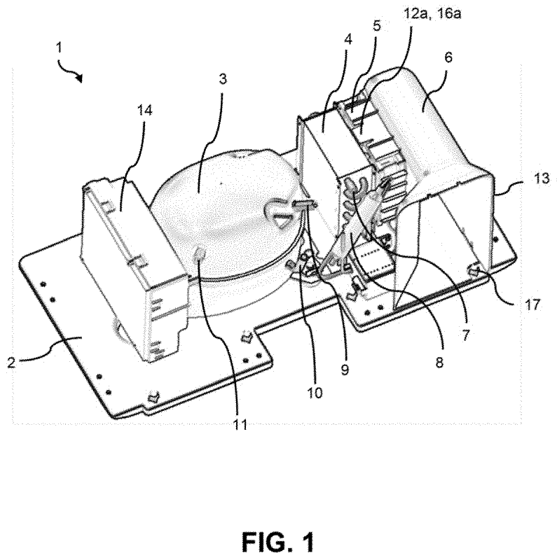

In FIG. 1 an embodiment of the compressor cooling aggregate 1 is shown including a compressor base plate 2 onto which the compressor 3, the condenser 4, the fan 5 and the fan adapter 6 are mounted. Also present at the compressor base plate 2 is the throttle 8. The coolant line 7 is cut off in FIG. 1 merely for visibility reasons. Of course, in the working compressor cooling aggregate 1, the coolant line 7 is a closed loop which connects, in the coolant flow direction, the compressor 3, the condenser 4, the throttle 8 and the evaporator (not shown).

The fan adapter 6 is mounted on and directly coupled to the compressor base plate 2. The fan adapter 6 is furthermore directly coupled to the fan 5 by a first snap structure 16a. In particular, the fan adapter 6 has a first snap-in nose 12a extending therefrom that engages with one edge of the fan 5.

The fan adapter 6 is funnel-shaped, so that, at least in sections, the airflow path increases in cross-sectional area in the direction from the fan 5 to the outside. Thus, the cross-sectional area of the air flow path in the fan adapter 6 has its maximum size at or near the outer edge 13 of the fan adapter 6.

Within the condenser 4, the coolant line 7 runs in a serpentine manner and air, forced by the fan 5, can pass through the condenser 4, thereby dissipating the heat from the coolant line 7. The airflow direction can change, that is, the air can either be blown from the fan 5 through the condenser 4, or the other way around. In order to reduce leakage of airflow pressure and isolate the cold air from the warmed-up air, the connection between the fan adapter 6, the fan 5 and the condenser 4 is very close. In particular, the fan 5 directly abuts to a side of the condenser 4 and, as already mentioned above, the fan 5 is directly coupled to the fan adapter 6.

The compressor 3 is mounted approximately in the center of the compressor base plate 2. The compressor 3 has the inlet 9 and the outlet 10 for the coolant and the compressor 3 furthermore has a service tube 11 which is closed during normal usage.

Furthermore, FIG. 1 illustrates the control unit 14 mounted on the compressor base plate 2. The control unit 14 controls the compressor 3 and the fan 5. For visibility reasons, the cables reaching from and to the control unit 14 are not shown in FIG. 1.

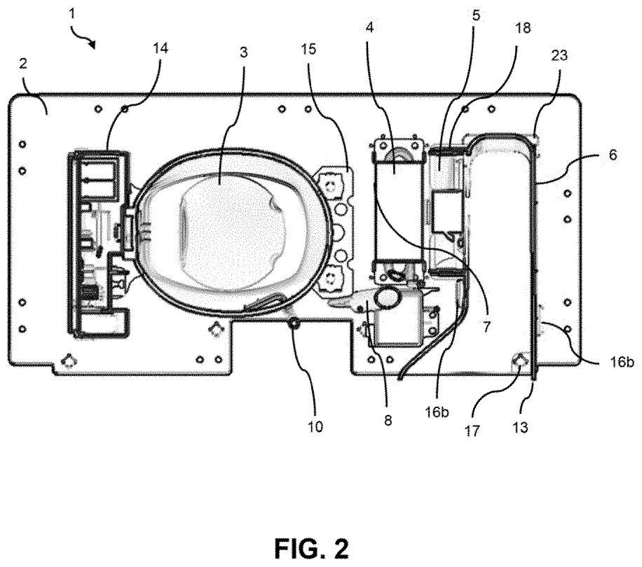

In the top view onto the compressor cooling aggregate 1 shown in FIG. 2, the arrangement of the components mounted to the compressor base plate 2 is shown in more detail. Furthermore, FIG. 2 illustrates a horizontal cross section of the compressor cooling aggregate 1. The compressor 3 is mounted to the compressor base plate 2 by means of a mounting bracket 15 present at the bottom of the compressor 3 which mounting bracket 15 is screwed onto the compressor base plate 2.

The fan 5 is laterally held in place by respective abutment portions 18 being present at the fan adapter 6. The abutment portions 18 prevent the fan 5 from moving with respect to the fan adapter 6 in a horizontal direction along the side of the fan adapter 6. The fan adapter 6 is fixed to the compressor base plate 2 by means of the second snap structure 16b. The fan adapter 6 is not fixed at the compressor base plate 2 by any further means, like screws or the like. The screw 17 is for mounting the compressor base plate 2 to the refrigerator or cooling box and the fan adapter 6 has the recess 28 in the region of the screw 17. Thus, screw 17 does not hold or fix the fan adapter 6 to the compressor base plate 2.

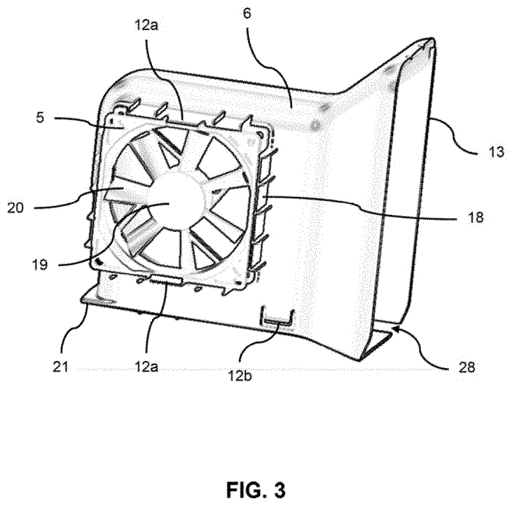

In FIG. 3, the fan 5 is shown in more detail that consists essentially of a propeller 19 having a plurality of air blades 20. The fan 5 is fixed to the fan adapter 6 by two first snap structures 16a on the upper edge and the lower edge of the fan 5, respectively. Furthermore, the abutment portions 18 are present at each side of the mounted fan 5 so that, as a result, without releasing the first snap structure 16a, the fan 5 is fixed in its position. As mentioned above, the fan 5 is not fixed by any further means like screws. Furthermore, the fan 5 is exclusively fixed to the fan adapter 6 and no other coupling means are present to separately couple the fan 5 to either the condenser 4 or to the compressor base plate 2.

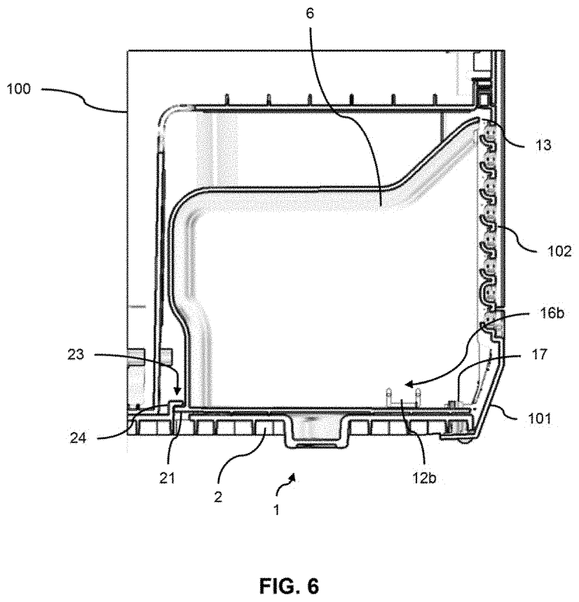

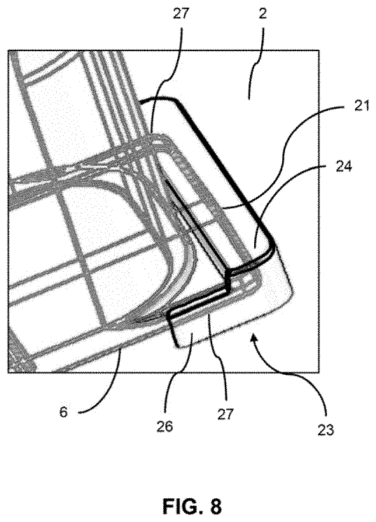

The mounted assembly of the fan adapter 6 and the fan 5 can be quickly and safely mounted to the compressor base plate 2 by means of the second snap structure 16b and the hook-in structure 23. The coupling with the hook-in structure 23 will be explained in more detail with reference to FIGS. 6 and 8 below.

The fan adapter 6, according to the shown embodiment, is formed as a one-piece component that includes all necessary fixing means like the snap-in noses 12a and 12b which form part of the first and second snap structures 16a and 16b, respectively, the tongue 21 which forms part of the hook-in structure 23, and the abutment portions 18.

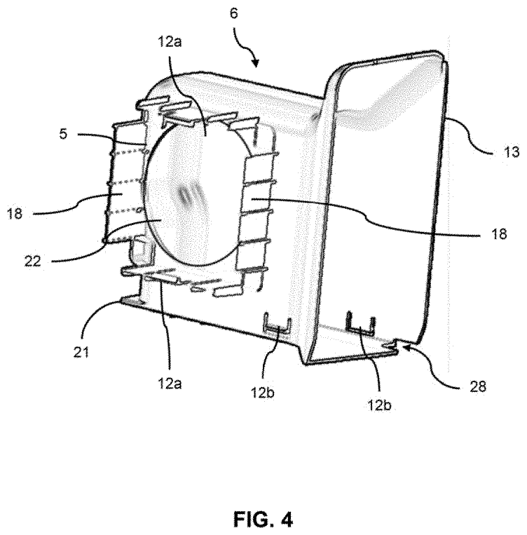

In FIG. 4, the fan adapter 6 without the fan 5 is shown. Leaving away the fan 5 reveals the presence of the opening 22 through which air forced by the fan 5 is intended to pass. The opening 22 is present approximately in the center of the surrounding abutment portions 18 and between the first snap-in noses 12a.

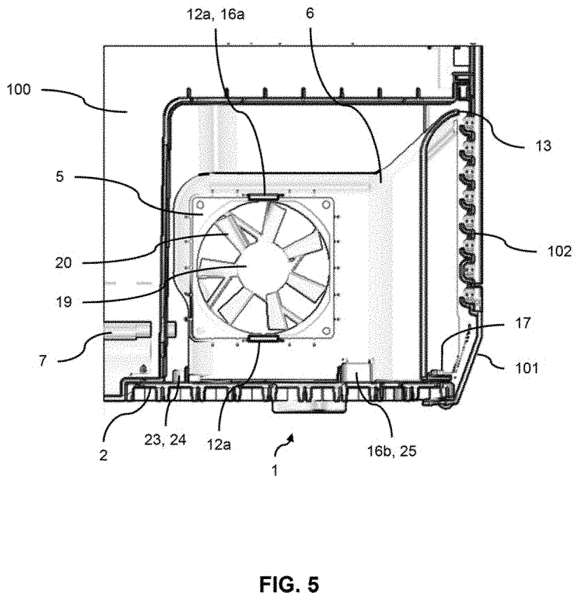

In FIG. 5, a cross section of the compressor cooling aggregate 1 mounted to the cooler 100 is illustrated. The compressor cooling aggregate 1 is mounted from below the cooler 100 into a corresponding cavity and the compressor base plate 2 is fixed to the cooler by the screws 17. The section of the coolant line 7 is shown by which the coolant is supplied to the evaporator (not shown) located in the cooler 100.

The fan 5 including its propeller 19 and air blades 20 is fixed to the fan adapter 6 via the first snap-in noses 12a of the first snap structure 16a.

The fan adapter 6 in turn is mounted to the compressor base plate 2 by means of the hook-in structure 23 and the second snap structure 16b.

The opening of the fan adapter 6 defined by the outer edge 13 of the fan adapter 6 is covered by a ventilation grill 102, provided at the outer cover 101 of the cooler 100. In this embodiment, the ventilation grill 102 does not cover the entire opening of the fan adapter 6 but only an upper area thereof. The lower part of the opening of the fan adapter 6 is covered by the outer cover 101 of the cooler 100 in order to prevent dirt from entering the cooler 100 near its bottom area.

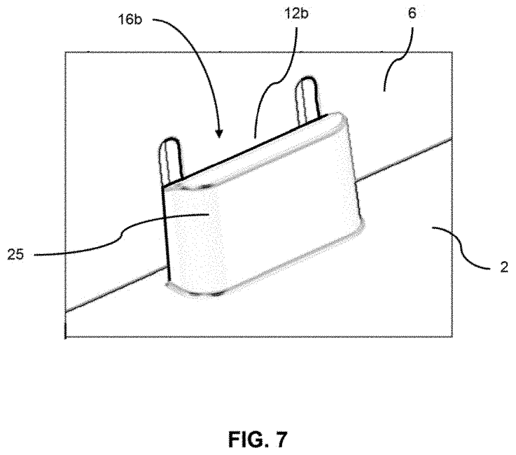

FIG. 6 shows another cross section similar to that shown in FIG. 5 but parallel thereto, in particular, a cross section right through the fan adapter 6. The fan adapter 6 is mounted to the compressor base plate 2 by first engaging the tongue 21 into a corresponding undercut portion 24, provided at the compressor base plate. Tongue 21 and undercut portion 24 together form the hook-in structure 23. Then, the front part of the fan adapter 6 at the side of its opening defined by the outer edge 13 of the fan adapter is pushed down to the compressor base plate 2 and the second snap-in nose 12b snaps into the corresponding snap-in cavity 25 as shown in FIG. 7. As mentioned above, no further fixing elements like screws or the like are used to fix the fan adapter 6 to the compressor base plate 2.

In FIG. 7, the second snap-in structure 16b is illustrated in more detail. The second snap-in nose 12b is engaged with the snap-in cavity 25 in order to fix the fan adapter 6 to the compressor base plate 2. The respective connection can be released again by pushing the second snap-in nose 12b so that it disengages from the snap-in cavity 25 and the fan adapter 6 can be lifted up from the compressor base plate 2.

In FIG. 8, the hook-in structure 23 at the rear side of the fan adapter 6 (opposite to the opening of the fan adapter 6 defined by the outer edge 13 of the fan adapter 6) is illustrated in more detail. For visibility reasons, the fan adapter 6 with its tongue 21 is illustrated by grid lines and the undercut portion 24 of the compressor base plate 2 is transparent so that the tongue 21 of the fan adapter 6 is visualized in its position when being engaged with the undercut portion 24. In addition, the undercut portion 24 has side walls that enclose the tongue 21 at both of its lateral ends 27. Thereby, lateral movement of the tongue 21, or the fan adapter 6 with respect to the undercut portion 24 is effectively prevented.

### LIST OF REFERENCE SIGNS

1 compressor cooling aggregate
2 compressor base plate
3 compressor
4 condenser
5 fan
6 fan adapter
7 coolant line
8 throttle
9 compressor inlet
10 compressor outlet
11 service tube
12a first snap-in nose
12b second snap-in nose
13 outer edge of fan adapter
14 control unit
15 mounting bracket
16a first snap structure
16b second snap structure
17 screw
18 abutment portion
19 propeller
20 air blades
21 tongue
22 opening
23 hook-in structure
24 undercut portion
25 snap-in cavity
26 side wall
27 lateral end of tongue
28 recess

1. A compressor cooling aggregate for a refrigerator or a cooler comprising a compressor base plate, a compressor, a condenser, a fan and a fan adapter, the fan adapter is configured to provide for an air flow path inside the fan adapter between the fan and the outside of the refrigerator or the cooler, wherein the fan is fixed to the fan adapter by at least one first fan snap structure.

2. The compressor cooling aggregate according to claim 1, wherein no screws are present to fix the fan to the fan adapter.

3. The compressor cooling aggregate according to claim 1, wherein the condenser is arranged close to the fan and the fan is arranged close to the fan adapter, thereby defining an air flow path between the condenser and the outside of the refrigerator or the cooler.

4. The compressor cooling aggregate according to claim 1, wherein the at least one first snap structure comprises a first snap-in nose being part of the fan adapter, which first snap-in nose engages with an edge of the fan.

5. The compressor cooling aggregate according to claim 1, wherein the fan adapter further comprises abutment portions extending away from the fan adapter in the vicinity of an area where the fan is fixed and the abutment portions are configured to laterally abut against the fan, to prevent the fan from moving with respect to the fan adapter and in a direction within the area where the fan is fixed.

6. The compressor cooling aggregate according to claim 1, wherein the fan adapter is fixed to the compressor base plate by at least one second snap structure.

7. The compressor cooling aggregate according to claim 6, wherein no screws are present to fix the fan adapter to the compressor base plate.

8. The compressor cooling aggregate according to claim 6, wherein the at least one second snap structure comprises a second snap-in nose being part of the fan adapter, which second snap-in nose engages with a snap-in cavity provided at the compressor base plate.

9. The compressor cooling aggregate according to claim 6, wherein the fan adapter is further fixed to the compressor base plate by a hook-in structure comprising a tongue and an undercut portion.

10. The compressor cooling aggregate according to claim 9, wherein the tongue is present at one side of the fan adapter and at the bottom of the fan adapter, and the tongue protrudes horizontally away from the fan adapter.

11. The compressor cooling aggregate according to claim 10, wherein the undercut portion is present at the compressor base plate and is configured to cover a portion of the tongue in order to prevent the tongue from being lifted to the above.

12. The compressor cooling aggregate according to claim 11, wherein the undercut portion comprises sidewalls configured to abut against lateral end portions of the tongue in order to prevent the tongue from laterally moving within the undercut portion.

13. The compressor cooling aggregate according to claim 9, wherein the fan adapter is fixed to the compressor base plate by at least two second snap structures and one hook-in structure.

14. A cooler or refrigerator wherein the cooler or refrigerator is equipped with a compressor cooling aggregate.

15. The cooler or refrigerator according to claim 14, wherein the cooler or refrigerator comprises a ventilation grill formed in an area of an outer cover of the cooler or refrigerator, the ventilation grill covers at least a portion of a cross-sectional area of the air flow path provided by the fan adapter, so that air flowing along the air flow path can pass the outer cover of the cooler or refrigerator through the ventilation grill.
